(19) United States
(12) Patent Application Publication
(10) Pub. No.: US 2023/0136753 A1
(43) Pub. Date: May 4, 2023

(54) Molded Rubber Product with Integrated Customizable Printed Label

(71) Applicant: Clearline Technologies Ltd., Winnipeg (CA)

(72) Inventors: Neil Krovats, Winnipeg (CA); Alain Masson, Winnipeg (CA); Stas Gershman, Winnipeg (CA)

(21) Appl. No.: 17/915,289

(22) PCT Filed: Apr. 16, 2021
(86) PCT No.: PCT/CA2021/050515

§ 371 Date: Sep. 28, 2022

Related U.S. Application Data
(60) Provisional application No. 63/010,803, filed on Apr. 16, 2020.

(51) Int. Cl. B29C 43/18; B29C 43/36; B29C 43/00; C08L 17/00

(52) U.S. Cl. CPC B29C 43/18; B29C 43/36; B29C 43/006; C08L 17/00; B29K 2021/00

(57) ABSTRACT

Described herein is a method for preparing a molded rubber product comprising a printed label that is integrally molded into the molded rubber product as part of the normal molding process in order to ensure the label becomes an integral part of the final molded rubber product. The printable label may be composed of a rubber based reflective sheeting.

### PRIOR APPLICATION INFORMATION

The instant application claims the benefit of US Provisional Patent Application U.S. Ser. No. 63/010,803, filed Apr. 16, 2020 and entitled “MOLDED RUBBER PRODUCT WITH INTEGRATED CUSTOMIZABLE PRINTED LABEL”, the entire contents of which are incorporated herein by reference for all purposes.

### BACKGROUND OF THE INVENTION

It is often desirable to customize molded rubber products with plates or labels that can be used for marketing, advertising and/or identification purposes. For example, flooring, ducts, lining, bricks, for example, an HVAC brick, and blocks are some examples of these types of molded rubber products.

Another example of a molded rubber product is a traffic safety product, for example, a rubber parking curb, a wheel stop or a car stop, is used for example to effectively guide cars when pulling into a parking spot or stall. Specifically, these can be used to designate individual parking spots as well as prevent damage to buildings, sidewalks, curbs, sign posts and walls.

Unlike concrete or plastic, which necessitate frequent replacement, recycled rubber car stops are safer and more durable.

Curbs are often produced with pre-molded holes and may be shipped with anchoring spikes or lag bolts for installation.

As will be apparent to one of skill in the art, such curbs are typically manufactured with a height of approximately 4-5 inches, although this is not a requirement of the invention. Similarly, such rubber curbs may be produced in any suitable length, for example, 19 inches, 22 inches, 36 inches, 48 inches, 60 inches, 72 inches or the like. Typically, the parking curb has a width at its base of about 4-10 inches. It is of note that curbs of other dimensions are known in the art and are within the scope of the invention.

In many cases, it is desirable to customize such a rubber parking curb with identifying indicia, for example, for identifying the parking spot associated with the rubber parking curb as being for a specific individual or for a specific type of user and/or for advertising purposes. Typically, such printed indicia are adhered to the traffic safety product post-production. However, one problem with such adhesively-attached printed indicia is that they can be removed, that is, peeled off, relatively easily.

Accordingly, there is a need for a traffic safety product with integrally molded customizable printed indicia for customizing the traffic safety product.

### SUMMARY OF THE INVENTION

According to an aspect of the invention, there is provided a method of producing a molded rubber product arranged to accept a customized printed label comprising:

providing a mold comprising a set of recessed grooves formed in an inner surface of the mold for forming a recessed pocket on a surface of the molded rubber product, said recessed pocket for accepting the customized printed label;

filling the mold with recycled rubber having an average particle size of 5-20 MESH (US Standard)

adding 4 to 10% polyurethane binder (v/w) to the recycled rubber in the mold; subjecting the mold to suitable temperature and pressure for forming the molded rubber product; and

removing the molded rubber product from the mold.

According to another aspect of the invention, there is provided a method of producing a molded rubber product arranged to accept a customized printed label comprising:

providing a mold comprising a set of recessed grooves formed in an inner surface of the mold for forming a recessed pocket on a surface of the molded rubber product, said recessed pocket for accepting the customized printed label;

filling the mold with recycled rubber having an average particle size of 5-20 MESH (US Standard)

adding 4 to 10% polyurethane binder (v/w) to the recycled rubber in the mold; subjecting the mold to suitable temperature and pressure for forming the molded rubber product;

removing the molded rubber product from the mold, and

mounting a replaceable label into the recessed pocket.

According to another aspect of the invention, there is provided a method of producing a molded rubber product with an integrated customizable printed label comprising:

printing customized indicia on a label composed of rubber based reflective sheeting;

inserting the printed label into a mold for the molded rubber product;

filling the mold with recycled rubber having an average particle size of 5-20 MESH (US Standard)

adding 4 to 10% polyurethane binder (v/w) to the recycled rubber in the mold;

subjecting the mold to suitable temperature and pressure for forming the molded rubber product; and

removing the traffic safety product from the mold.

### DETAILED DESCRIPTION OF THE FIGURES

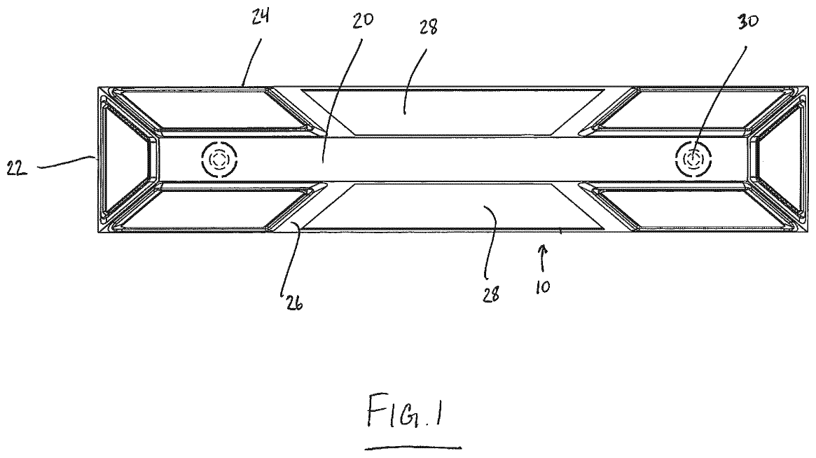

FIG. 1 is a top view of one embodiment of the molded rubber product.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a method for preparing a molded rubber product comprising a printed label that is integrally mounted onto the molded rubber product either as part of the normal molding process or mounted onto a recessed portion of the rubber product such that in both cases the edges of the label are protected by the edges of the recessed portion or pocket so as to ensure the label becomes an integral part of the molded rubber product.

As discussed herein, during the molding process, the mold is arranged such that the molded rubber forms a protective ridge around the edges of a recessed portion or recessed pocket. That is, an elevated or raised ridge is formed around the edges of the recessed pocket.

As discussed herein, in some embodiments, a printed label is inserted into the mold during the molding process such that no edge of the label is exposed and so that the label is integral with the molded rubber product, that is, so that the label does not extend outwardly from the molded rubber product.

In other embodiments of the invention, the molded rubber product is prepared as described for the embodiments in which the custom printed label is integrally molded into the molded rubber product except that the label is not placed between the recesses in the mold, such that a recessed pocket is formed on a surface of the molded rubber product. As discussed herein, this recessed pocket can be used for mounting of a printed label therein wherein the printed label is sized and shaped such that the edges of the printed label fit within the recessed pocket and are protected by the edges of the recessed pocket.

In some embodiments of the invention, the mold for the molded rubber product is arranged such that the region of the mold that forms the recessed pocket includes indicia such as for example a logo that is formed either within or on the surface of the recessed pocket onto which the post-production label is mounted. In a preferred embodiment, the indicia serve as a means for example a logo or trademark for identifying the manufacturer of the molded rubber product.

As will be appreciated by one of skill in the art, a label that is placed onto the flat surface of a molded rubber product post-production will have exposed edges and will extend outwardly from the finished product.

In some embodiments, the protective ridge of elevated rubber around the perimeter of the customizable printed label is formed during the molding process by a set of recessed grooves formed in the inner surface of the mold used for the production of the molded rubber product. Specifically, these grooves define the label insertion site and define a perimeter around the label. Accordingly, these grooves are positioned and arranged on the inner surface of the mold to correspond to the shape of the label being integrated into the molded rubber product. As will be appreciated by one of skill in the art, the grooves can be arranged on the inner surface of the mold so as be of any suitable size and/or shape for a corresponding label.

As will be appreciated by one of skill in the art, if a label is not inserted in the mold during the molding process, a recessed pocket will be formed, as discussed herein.

Furthermore, as discussed herein, the recessed pocket is characterized in that it is shaped so as to correspond to the shape of the custom printed label so that once the custom printed label has been inserted into the location of the recessed pocket, either prior to the molding process or after the molding process, referred to herein as “post-production”, the edges of the recessed pocket press against the edges of the label such that edges of the label are not exposed. It is further of note that the label is mounted into the mold or onto the finished product post-production without an adhesive.

In some embodiments of the invention, the grooves are approximately ⅛ or 1/16 of an inch deep. As will be apparent to one of skill in the art, this will result in a protective ridge forming around the integrated label so that no edges of the label are exposed, as discussed herein.

As will be appreciated by one of skill in the art, adhesively applying a label post-production results in a label with exposed edges that can be pried off or peeled off the molded rubber product. However, the protective ridge that forms around the label during the compression molding process prevents the edges of the label from being accessible, thereby preventing edges of the label from being damaged, for example, from being picked at or scraped away. As a result of the protective edging and the integral molding of the label, the label is bonded to the molded rubber product to such a degree that it can not be removed by human hands.

It is further of note that molding of the label onto the outer surface of the finished product provides a much stronger bond than adhesively applying a label to the molded rubber product.

As will be appreciated by one of skill in the art, if no label is inserted during the molding process, a recessed pocket will be formed, as discussed herein.

In some embodiments of the invention, the molded rubber product further comprises a recessed pocket for mounting of a replaceable label, as discussed below. In further embodiments, the recessed pocket has the same or similar dimensions and shape as the replaceable label and has a depth of approximately ⅛ or 1/16 of an inch, as discussed herein. For example, in some embodiments, the replaceable label or plate may have a thickness of approximately 1/16 of an inch and the similarly shaped recessed pocket may have a depth of approximately ⅛ of an inch. As will be appreciated by one of skill in the art, as a result of this arrangement, when the replaceable label or plate is inserted into the recessed pocket, the edges of the replaceable plate are surrounded by the sides of the recessed pocket so that the edges of the replaceable plate are not exposed and so that the replaceable plate does not extend outwardly from the finished molded rubber product, as discussed herein.

In some embodiments of the invention, the mold for the molded rubber product is arranged such that the region of the mold that forms the recessed pocket includes indicia such as for example a logo that is formed either within or on the surface of the recessed pocket onto which the post-production label is mounted. In a preferred embodiment, the indicia serve as a means for example a logo or trademark for identifying the manufacturer of the molded rubber product.

It is of note that as used herein, “approximately” or “about” regarding depths of the grooves and the recessed pocket and/or the thickness of the customizable printable label and the replaceable label refers to plus or minus 20%.

In addition to being resistant to the conditions necessary for the compression molding process, the label must have sufficient abrasion and tensile strength characteristics that ensure that the label will last during the life cycle of the product.

Furthermore, in some embodiments, the label may have some reflective characteristics so that the label is visible in low light environments, for example, when a vehicle is entering a parking spot during conditions of low ambient light, that is, low daylight. That is, the label is reflective so that for example light from a vehicle's headlights are sufficient for reflection of the printed label so that the printed label can be visualized even in darkness.

In some embodiments, the label is capable of being printed on using UV stable inks and is capable of containing high resolution, multi coloured images.

As will be appreciated by one of skill in the art, bonding the label to the product as a separate operation, that is, post-production of the product, is not optimal as the cost of applying the label to the product would be excessive. In addition, the bond between the label and the product would not be as strong as when the label is molded into the product, as discussed herein.

Thus, as will be appreciated by one of skill in the art, the label needs to be able to withstand the molding conditions and also display strong bonding properties in order to survive exposure to the elements, collisions and even vandalism can cause wear and tear on the exposed surfaces of the molded rubber products, including any labels mounted thereon. However, very few materials have all of the required properties.

For example, the inventors initially believed that a suitable label could be manufactured from any of a variety of vinyl-based materials as vinyls are typically strong and easily printable. However, surprisingly, vinyls were found to have difficulty bonding to the rubber product. This seems to be mostly due to the chemical structures of the vinyls not being able to form a strong bond (chemical or mechanical) with the binder used to mold the rubber product. While not wishing to be bound to a particular theory or hypothesis, it is believed that the smooth surface structure of the vinyls also results in very little surface area for the binder to bond with. It is also difficult to find vinyl materials that have reflective characteristics

Given the need for a good bond to be formed between the finished product and the integral label, the inventors next tested cloth labels. Although a good bond can be achieved, the material does not weather very well once the finished product is in use, that is, placed outside.

The inventors also tested a variety of photo papers. While these materials showed excellent printing characteristics, as would be expected, these materials provided to be too thin to retain their integrity when exposed to the elements that the traffic the product will be exposed to. The photo papers also showed poor bonding properties.

The inventors also tested polypropylene labels. Although strong and easily printable, the polypropylene labels had difficulty bonding onto the rubber product. While not wishing to be bound to a particular theory or hypothesis, the inventors believe that the chemical structure of the propylene is such that it is not able to form a strong bond (chemical or mechanical) with the binder used to mold the rubber product. Similar to the vinyl labels, the polypropylene labels also have a generally smooth structure which provides very little functional surface area for the binder to bond with. It is also of note that it is difficult to find polypropylene materials that have reflective characteristics

The inventors then tested labels made from LEXAN™, a polycarbonate resin thermoplastic. Although strong and easily printable, LEXAN has difficulty bonding onto the rubber product. While not wishing to be bound to a particular theory or hypothesis, this seems to be mostly attributed to the chemical structure of the material not being able to form a strong bond (chemical or mechanical) with the binder used to mold the rubber product. The smooth structure also results in very little surface area for the binder to bond with. It is also of note that it is difficult to find LEXAN materials that have reflective characteristics.

Finally, the inventors tested rubber based reflective sheeting. Surprisingly, the bond between this material and the end product is superior to the previously tested materials. This is due to both the substrate of the material being made of a rubber as well as having a rough backing which creates significantly more surface area for the binder to bond with. The rubber based reflective sheeting is also very receptive to printing. In some embodiments, rubber based reflective sheeting comprising with reflective glass beading on the top surface of the printed label is used to enhance visibility of the product in poorly lit environments.

As will be known by those of skill in the art, one example of such a rubber based reflective sheeting is known as “pavement marking tape”. Specifically, pavement marking tape is typically used to provide superior daytime visibility as well as excellent nighttime reflectivity for Portland cement and bituminous surfaces. Such material consists of a blend of polymer resins, pigments and filters. In some embodiments, this composition is evenly dispersed with glass spheres for improved reflectivity.

As will be appreciated by one of skill in the art, various methods were used to print onto the labels such as digital printing (both with flat bed and roll printers) as well as silk screening. Various degrees on bonding of the ink were realized in using both methods. In a preferred embodiment, UV stable inks are used in the printing process. Due to UV stability being a major requirement for this product, solvent based inks must be used, as they are used for printing banners that are used outdoors. Lower quality and/or inks used primarily for indoor applications will fade and discolour too quickly.

It is of note that other printing methods such as silk screening were found to be unsuitable due to the start up cost and time of making screens each time a new design is required as well as the slow printing process, especially when multiple colours are used. Silk screening is also unsuitable for the creation of high-resolution images. As will be appreciated by one of skill in the art, digital printers have the ability to receive electronic files and print a different high-resolution image in seconds, therefore allowing for custom printing solutions much faster and cheaper than can be achieved through silk screening.

As discussed herein, in preferred embodiments, the rubber-based reflective sheeting is printed with a high resolution laser printer or inkjet printer, for example, a high resolution printer that has an outlet resolution of at least 600 dpi, at least 720 dpi, at least 1200 dpi, at least 1440 dpi, at least 2400 dpi or at least 2880 dpi. More preferably, the printer has an outlet resolution of at least 1440 dpi, at least 2400 dpi or at least 2880 dpi.

Consequently, it is possible to print full UV stable, colour/high resolution images onto the product. That is, a client can send an image electronically (by email for example), where the image is then sent to the printer, where the image is printed onto the label, thereby preparing a printed label for molding into the finished product, all within minutes at no extra cost to the customer for all this flexibility.

In contrast, with silk screening, it is necessary to create new screens. Furthermore, both the printing process and the drying process are considerably slower. In addition, each new image/change would result in additional set up costs and delays when silk screening.

According to an aspect of the invention, there is provided a method of producing a molded rubber product arranged to accept a customized printed label comprising:

providing a mold comprising a set of recessed grooves formed in an inner surface of the mold for forming a recessed pocket on a surface of the molded rubber product, said recessed pocket for accepting the customized printed label;

filling the mold with recycled rubber having an average particle size of 5-20 MESH (US Standard)

adding 4 to 10% polyurethane binder (v/w) to the recycled rubber in the mold;

subjecting the mold to suitable temperature and pressure for forming the molded rubber product; and

removing the molded rubber product from the mold.

The mold may be subjected to a temperature of 150-250 degrees F.

The mold may be subjected to a pressure of 2,000 to 3,500 PSI through a hydraulic press applying 300-600 tons.

The mold may be subjected to a temperature of 150-250 degrees F. and a pressure of 2,000 to 3,500 PSI through a hydraulic press applying 300-600 tons of pressure for 7-12 minutes.

The recessed pocket may have a depth of approximately ⅛ of an inch.

In some embodiments, prior to filling the mold with recycled rubber, a printed label composed of rubber based reflective sheeting is inserted into the recessed pocket.

The rubber based reflective sheeting may be printed with customized indicia with a resolution of at least 600 dpi with UV stable ink.

The replaceable label may be composed of a metallic substrate, for example, aluminum, or a hard plastic substrate, for example, LEXAN or HDPE.

The replaceable label may be printed with customized indicia with a resolution of at least 600 dpi with UV stable ink.

According to another aspect of the invention, there is provided a method of producing a molded rubber product arranged to accept a customized printed label comprising:

providing a mold comprising a set of recessed grooves formed in an inner surface of the mold for forming a recessed pocket on a surface of the molded rubber product, said recessed pocket for accepting the customized printed label;

filling the mold with recycled rubber having an average particle size of 5-20 MESH (US Standard)

adding 4 to 10% polyurethane binder (v/w) to the recycled rubber in the mold;

subjecting the mold to suitable temperature and pressure for forming the molded rubber product;

removing the molded rubber product from the mold, and

mounting a replaceable label into the recessed pocket.

The mold may be subjected to a temperature of 150-250 degrees F.

The mold may be subjected to a pressure of 2,000 to 3,500 PSI through a hydraulic press applying 300-600 tons.

The mold may be subjected to a temperature of 150-250 degrees F. and a pressure of 2,000 to 3,500 PSI through a hydraulic press applying 300-600 tons of pressure for 7-12 minutes.

The recessed pocket may have a depth of approximately ⅛ of an inch.

The replaceable label may be composed of a metallic substrate, for example, aluminum or a hard plastic substrate, for example, LEXAN or HDPE.

The replaceable label may be printed with customized indicia with a resolution of at least 600 dpi with UV stable ink.

According to another aspect of the invention, there is provided a method of producing a molded rubber product with an integrated customizable printed label comprising:

printing customized indicia on a label composed of rubber based reflective sheeting;

inserting the printed label into a mold for the molded rubber product;

filling the mold with recycled rubber having an average particle size of 5-20 MESH (US Standard)

adding 4 to 10% polyurethane binder (v/w) to the recycled rubber in the mold;

subjecting the mold to suitable temperature and pressure for forming the molded rubber product; and

removing the traffic safety product from the mold.

In some embodiments, the protective ridge of elevated rubber around the perimeter of the customizable printed label is formed during the molding process by a set of recessed grooves formed in the inner surface of the mold used for the production of the molded rubber product. Specifically, these grooves define the label insertion site and define a perimeter around the label. Accordingly, these grooves are positioned and arranged on the inner surface of the mold to correspond to the shape of the label being integrated into the molded rubber product. As will be appreciated by one of skill in the art, the grooves can be arranged on the inner surface of the mold so as be of any suitable size and/or shape for a corresponding label.

In some embodiments of the invention, the grooves are approximately ⅛ or 1/16 of an inch deep. As will be apparent to one of skill in the art, this will result in a protective ridge forming around the integrated label so that no edges of the label are exposed, as discussed herein.

In some embodiments of the invention, the label insertion site is on a non-vertical surface of the mold, for example, on a slanted or diagonal surface of the mold.

In some embodiments, the molded rubber product is a traffic safety product, for example, a rubber traffic curb or wheel stop or parking curb, as discussed herein. However, as will be appreciated by one of skill in the art, any suitable rubber molded product can be made with a custom-printed, integrated label as described herein, such as, for example but by no means limited to, an HVAC brick or block, rubber flooring, rubber ducts or the like.

As will be known by those of skill in the art, the traffic safety product, for example, a rubber traffic curb, has a length, a height and a width which define a top, a base, a front face and a rear face. In some embodiments, the rubber traffic curb is wider at the base than at the top.

One example of such a rubber traffic curb is shown in FIG. 1.

As can be seen from FIG. 1, the rubber traffic curb 10 comprises a top 20, a base 22, a front 24 and a back 26.

It is of note that in the embodiment shown in FIG. 1, the front 24 and the back 26 are arbitrary, but this may not necessarily always be the case.

In the embodiment shown in FIG. 1, the top 20 of the rubber traffic curb 10 includes two pre-molded anchoring holes 30 extending through the top 20 of the rubber traffic curb 10 to the base 22 of the rubber traffic curb 10 for mounting the rubber traffic curb to asphalt or concrete, as discussed herein. As will be appreciated by one of skill in the art, the specific positioning of the anchoring holes 30 is dependent on several factors, for example, the specific length of the rubber traffic curb 10 and customer preference. Accordingly, there may be 1, 2, 3, 4, 5 or more anchoring holes 30 which may not necessarily be equally spaced apart.

In FIG. 1, there is a recessed pocket 28 on the front 24 and the back 26 of the rubber traffic curb 10. In some embodiment, a printed label can be mounted to the recessed pocket 28 post-production. For example, the printed label, for example, a replaceable printed label can be for example screwed into or riveted to the body of the rubber traffic curb using means known in the art. It is of note that in these embodiments, the indicia such as for example a logo that is formed either within or on the surface of the recessed pocket onto which the post-production label is mounted may be positioned for example between either edge of the recessed pocket 28. As will be appreciated by one of skill in the art, the front face of the traffic safety product is the face of the traffic safety product that faces the parking spot. While the printed label(s) are described herein as being on the front face of the rubber parking curb, it is important to note that in some embodiments, the printed label(s) may be on the rear face as well as on the front face or instead of on the front face.

As will be apparent to one of skill in the art, such curbs are typically manufactured with a height of approximately 4-5 inches, although this is not a requirement of the invention. Similarly, such rubber curbs may be produced in any suitable length, for example, 22 inches, 36 inches, 48 inches, 60 inches, 72 inches or the like. Typically, the parking curb has a width at its base of about 4-10 inches. It is of note that curbs of other dimensions are known in the art and are within the scope of the invention.

Regardless of the specific length of the rubber traffic curb, the label(s) may be positioned thereon so that when in use the label is positioned so that the label will not be contacted by vehicle tires during parking.

In some embodiments of the invention, the mold is subjected to a temperature of 150-250 degrees F.

In some embodiments of the invention, the mold is subjected to a pressure of 2,000 to 3,500 PSI through a hydraulic press applying 300-600 tons.

In some embodiments of the invention, the mold is subjected to a temperature of 150-250 degrees F. and a pressure of 2,000 to 3,500 PSI through a hydraulic press applying 300-600 tons of pressure for 7-12 minutes.

As will be appreciated by one of skill in the art, the label composed of rubber based reflective sheeting will not distort, experience colour shift, blister due to heat, pressure or gassing which can result during the molding process.

In some embodiments, the molded rubber product is manufactured with an indented area on an outer surface of the product which allows for a replaceable plate or label to be received. As a result of this arrangement, the customer is able to customize a product quickly and also allows them to change the message or information on the molded rubber product as required/desired.

As a result of this arrangement, a second, replaceable label can be added to the finished product post-production of the molded rubber product, for example, a custom message/logo/trademark or the like printed on the replaceable label which is sent to the customer to apply onto their molded rubber product which may be already in use or stored in inventory.

In these embodiments, the replaceable label is composed of a suitable metallic (aluminum) or hard plastic (such as a Polycarbonate resin thermoplastic, commercially known as LEXAN™, or High Density Polyethylene (HDPE)) substrate as they will withstand considerable force without breaking or bending, for example, from the force of both foot and vehicular traffic.

The replaceable label is also printed with a high resolution printer, as described above.

In some embodiments of the invention, the molded rubber product further comprises a recessed pocket for mounting of a replaceable label, as discussed below. In further embodiments, the recessed pocket has the same or similar dimensions and shape as the replaceable label and has a depth of approximately ⅛ or 1/16 of an inch, as discussed herein. For example, in some embodiments, the replaceable label or plate may have a thickness of approximately 1/16 of an inch and the similarly shaped recessed pocket may have a depth of approximately ⅛ of an inch. As will be appreciated by one of skill in the art, as a result of this arrangement, when the replaceable label or plate is inserted into the recessed pocket, the edges of the replaceable plate are surrounded by the sides of the recessed pocket so that the edges of the replaceable plate are not exposed and so that the replaceable plate does not extend outwardly from the finished molded rubber product, as discussed herein.

In these embodiments, the replaceable label or plate is attached by the end user to the traffic safety product by any suitable method, for example, by rivets, bolts and nuts, or a screw.

As discussed above, in some embodiments, the replaceable label or plate is mounted into the recessed pocket that in some embodiments is positioned directly to the right of the protective edging that surrounds the in-molded printed label. As will be appreciated by one of skill in the art and as discussed herein, the pocket is slightly recessed for the metal or plastic plate to be installed therein. Since in some embodiments the recess is only about 1/16 or ⅛ of an inch deep, such that the recessed pocket is not easily visible or discernible, and as such, this recessed pocket will not reflect poorly on the product or make the molded rubber product appear like something is missing. Should the customer choose to install a metal or plastic plate onto the product subsequently, the plate would fit neatly into this recess creating a very nice finish to the product as well as protect the plate from foot and vehicular traffic. Specifically, as discussed above, because of the difference in the depth of the recessed pocket and the thickness of the replaceable label or plate, a protective ridge is effectively formed around the edges of the replaceable plate.

While the preferred embodiments of the invention have been described above, it will be recognized and understood that various modifications may be made therein, and the appended claims are intended to cover all such modifications which may fall within the spirit and scope of the invention.

1. A method of producing a molded rubber product arranged to accept a customized printed label comprising:
providing a mold comprising a set of recessed grooves formed in an inner surface of the mold for forming a recessed pocket on a surface of the molded rubber product, said recessed pocket for accepting the customized printed label;
filling the mold with recycled rubber having an average particle size of 5-20 MESH (US Standard)
adding 4 to 10% polyurethane binder (v/w) to the recycled rubber in the mold;
subjecting the mold to suitable temperature and pressure for forming the molded rubber product; and
removing the molded rubber product from the mold.

2. The method according to claim 1 wherein the mold is subjected to a temperature of 150-250 degrees F.

3. The method according to claim 1 wherein the mold is subjected to a pressure of 2,000 to 3,500 PSI through a hydraulic press applying 300-600 tons.

4. The method according to claim 1 wherein the mold is subjected to a temperature of 150-250 degrees F. and a pressure of 2,000 to 3,500 PSI through a hydraulic press applying 300-600 tons of pressure for 7-12 minutes.

5. The method according to claim 1 wherein the recessed pocket has a depth of approximately ⅛ of an inch.

6. The method according to claim 1 wherein, prior to filling the mold with recycled rubber, a printed label composed of rubber based reflective sheeting is inserted into the recessed pocket.

7. The method according to claim 6 wherein the rubber based reflective sheeting is printed with customized indicia with a resolution of at least 600 dpi.

8. The method according to claim 7 wherein the rubber based reflective sheeting is printed with UV stable ink.

9. The method according to claim 1 wherein the customized printed label is composed of a metallic substrate or a hard plastic substrate.

10. The method according to claim 9 wherein the metallic substrate is aluminium.

11. The method according to claim 9 wherein the hard plastic substrate is LEXAN or HDPE.

12. The method according to claim 10 wherein the customized printed label is printed with customized indicia with a resolution of at least 600 dpi.

13. The method according to claim 12 wherein the customized printed label is printed with UV stable ink.

14. A method of producing a molded rubber product arranged to accept a customized printed label comprising:
providing a mold comprising a set of recessed grooves formed in an inner surface of the mold for forming a recessed pocket on a surface of the molded rubber product, said recessed pocket for accepting the customized printed label;
filling the mold with recycled rubber having an average particle size of 5-20 MESH (US Standard)
adding 4 to 10% polyurethane binder (v/w) to the recycled rubber in the mold;
subjecting the mold to suitable temperature and pressure for forming the molded rubber product;
removing the molded rubber product from the mold, and
mounting a replaceable label into the recessed pocket.

15. The method according to claim 14 wherein the mold is subjected to a temperature of 150-250 degrees F.

16. The method according to claim 14 wherein the mold is subjected to a pressure of 2,000 to 3,500 PSI through a hydraulic press applying 300-600 tons.

17. The method according to claim 14 wherein the mold is subjected to a temperature of 150-250 degrees F. and a pressure of 2,000 to 3,500 PSI through a hydraulic press applying 300-600 tons of pressure for 7-12 minutes.

18. The method according to claim 14 wherein the recessed pocket has a depth of approximately ⅛ of an inch.

19. The method according to claim 15 wherein the customized printed label is composed of a metallic substrate or a hard plastic substrate.

20. The method according to claim 19 wherein the metallic substrate is aluminium.

21. The method according to claim 19 wherein the hard plastic substrate is LEXAN or HDPE.

22. The method according to claim 19 wherein the customized printed label is printed with customized indicia with a resolution of at least 600 dpi.

23. The method according to claim 22 wherein the customized printed label is printed with UV stable ink.

24. A method of producing a molded rubber product with an integrated customizable printed label comprising:
printing customized indicia on a label composed of rubber based reflective sheeting;
inserting the printed label into a mold for the molded rubber product;
filling the mold with recycled rubber having an average particle size of 5-20 MESH (US Standard)
adding 4 to 10% polyurethane binder (v/w) to the recycled rubber in the mold;
subjecting the mold to suitable temperature and pressure for forming the molded rubber product; and
removing the molded rubber product from the mold.

25. The method according to claim 24 wherein the mold is subjected to a temperature of 150-250 degrees F.

26. The method according to claim 24 wherein the mold is subjected to a pressure of 2,000 to 3,500 PSI through a hydraulic press applying 300-600 tons.

27. The method according to claim 24 wherein the mold is subjected to a temperature of 150-250 degrees F. and a pressure of 2,000 to 3,500 PSI through a hydraulic press applying 300-600 tons of pressure for 7-12 minutes.

28. The method according to claim 24 wherein the mold comprises a set of recessed grooves formed in an inner surface of the mold for insertion of the label therebetween such that the grooves form a perimeter around the label.

29. The method according to claim 24 wherein the molded rubber product further comprises a recessed pocket for mounting of a replaceable plate therein.

30. The method according to claim 24 wherein the recessed pocket has a depth of approximately ⅛ of an inch.
